(19) United States
(12) Patent Application Publication
(10) Pub. No.: US 2004/0206249 A1
(43) Pub. Date: Oct. 21, 2004

(54) Device for holding a foodstuff

(76) Inventor: Vincent Zangari, Los Angeles, CA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/417,552

(22) Filed: Apr. 17, 2003

(51) Int. Cl. A23P 1/00

(52) U.S. Cl. 99/426

(57) ABSTRACT

A preferred embodiment of a device includes a lid for holding at least a portion of a foodstuff, a body for supporting the lid while the foodstuff is consumed, and a noisemaking device secured to the body so that the noisemaking device and the body cooperate to produce a sound in response to the passage of air through the noisemaking device.

### FIELD OF THE INVENTION

The present invention relates to a device for holding a foodstuff such as a frankfurter

### BACKGROUND OF THE INVENTION

Foodstuffs such as frankfurters are commonly served at public and private gatherings such as sporting events, circuses, barbecues, parties, etc. Frankfurters are typically served on plates, or on trays tailored to the shape of the frankfurter. Toppings such as mustard, relish, sauerkraut, and ketchup are commonly applied to frankfurters. The toppings can be applied before the frankfurter is served to the consumer. Alternatively, the toppings can be applied by the consumer from dispensers or packets.

Plates and trays used to hold frankfurters can be awkward for the consumer to hold or otherwise support, particularly at public gatherings where a table or other convenient resting place is not available. Moreover, applying toppings to a frankfurter from packets or dispensers can be inconvenient and messy. Also, many types of plates and trays do not prevent toppings or juices from the frankfurter from dripping onto the consumer. This characteristic can be particularly disadvantageous where the consumer is a young child.

Plates and trays used to hold frankfurters, in general, are not visually appealing to consumers (particularly children), and do not have any additional uses. Hence, the plates and trays are often discarded after use.

### SUMMARY OF THE INVENTION

A preferred embodiment of a holder for a foodstuff comprises a substantially cone-shaped body, and a lid comprising a main portion, a lip adjoining the main portion for securing the lid to a first end of the body, and an elongated member adjoining the main portion for receiving at least a portion of the foodstuff. A preferred embodiment also comprises a noisemaking device fixedly coupled to a second end of the body.

A preferred embodiment of a device for holding a foodstuff comprises a substantially cone-shaped body, a lid for mating with the body and receiving at least a portion of the foodstuff, and a noisemaking device for generating a sound. The noisemaking device is in fluid communication with an internal volume of the body so that the body at least one of amplifies and projects the sound when the lid is removed from the body.

A preferred embodiment of a device comprises a lid for holding at least a portion of a foodstuff, a body for supporting the lid while the foodstuff is consumed, and a noisemaking device secured to the body so that the noisemaking device and the body cooperate to produce a sound in response to the passage of air through the noisemaking device.

Another preferred embodiment of a device for holding a foodstuff comprises a substantially cone-shaped body, and a lid comprising a main portion, a lip adjoining the main portion for securing the lid to the body, an elongated member projecting from the main portion for receiving at least a portion of the foodstuff, and a well adjoining the main portion for receiving a topping for the foodstuff.

Another preferred embodiment of a device comprises a lid for holding at least a portion of a foodstuff, a body for supporting the lid while the foodstuff is consumed, and one of a whistle and a horn in fluid communication with an internal volume of the body. The lid can be removed from the body so that the one of a whistle and a horn and the lid cooperate to produce a sound in response to the passage of air through the one of a whistle and a horn.

### BRIEF DESCRIPTION OF THE DRAWINGS

The foregoing summary, as well as the following detailed description of a presently-preferred embodiment, is better understood when read in conjunction with the appended drawings. For the purpose of illustrating the invention, the drawings show an embodiment that is presently preferred. The invention is not limited, however, to the specific instrumentalities disclosed in the drawings. In the drawings:

FIG. 1 is a perspective view of a preferred embodiment of a device for holding a foodstuff, in an unassembled condition;

FIG. 2 is a side view of the device shown in FIG. 1, in an assembled condition;

FIG. 3 is a top perspective view of a lid of the device shown in FIGS. 1 and 2;

FIG. 4 is a bottom perspective view of the lid shown in FIG. 3;

FIG. 5 is a cross-sectional view of the lid shown in FIGS. 3 and 4, taken along the line “A-A” of FIG. 3;

FIG. 6 is a top perspective view of a body and a noisemaking device of the device shown in FIGS. 1 and 2;

FIG. 7 is a cross-sectional view of the body and the noisemaking device shown in FIG. 6, taken along the line “B-B” of FIG. 6;

FIG. 8 is a perspective view of an alternative embodiment of the lid shown in FIGS. 3-5; and

FIG. 9 is a side view of alternative embodiment of the lid shown in FIGS. 6 and 7.

### DESCRIPTION OF PREFERRED EMBODIMENTS

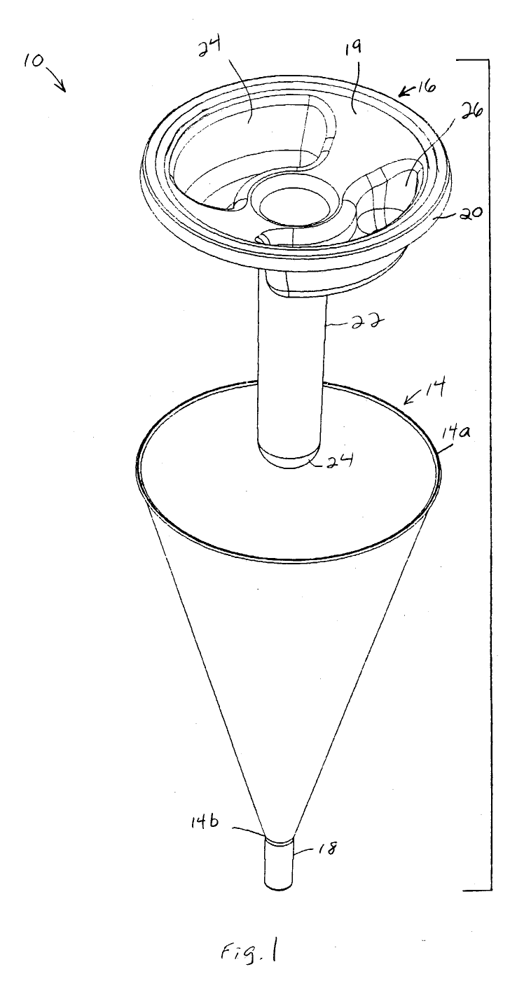

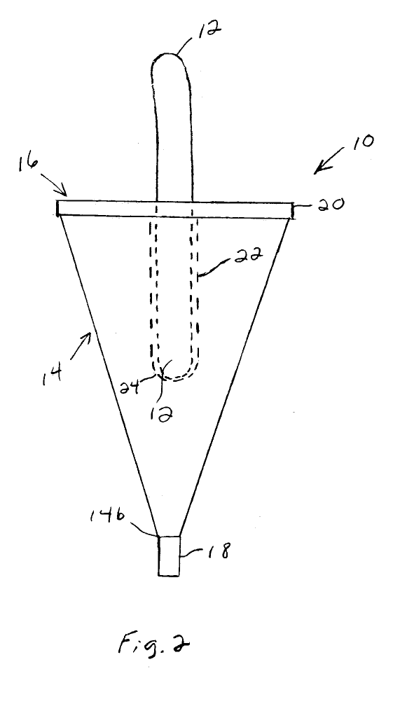

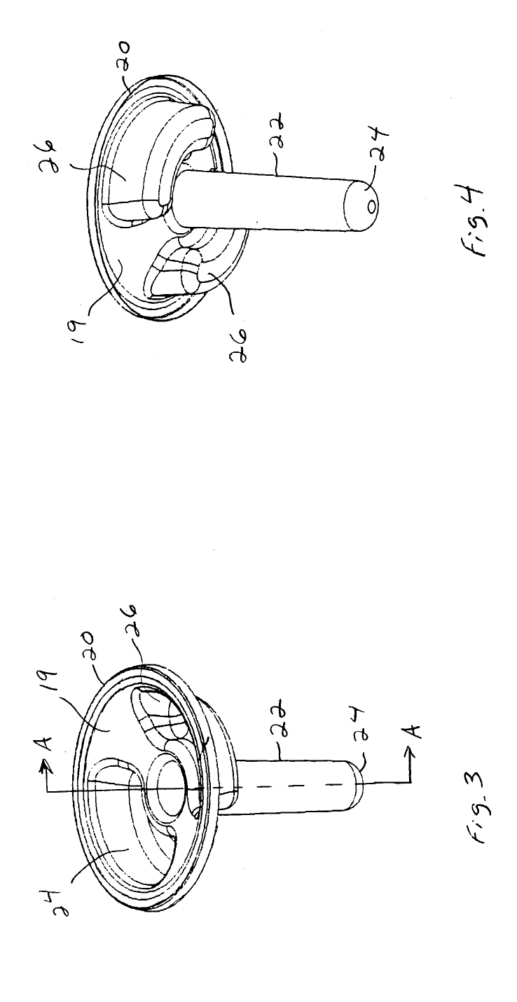

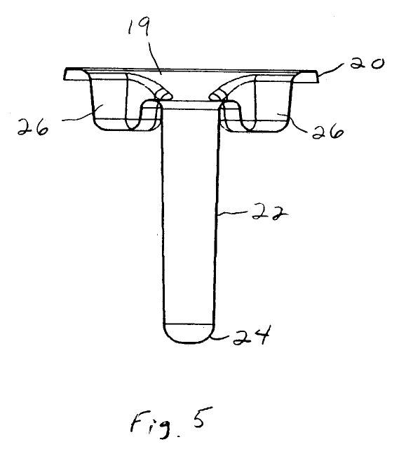

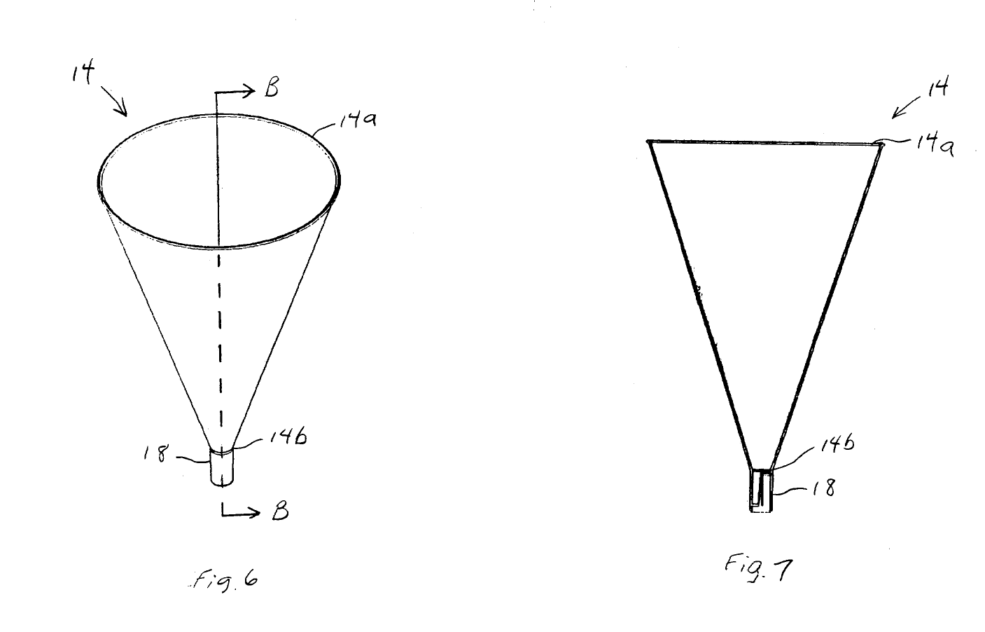

FIGS. 1-7 depict a preferred embodiment of a device 10 for holding a foodstuff. The device 10 is configured to hold a frankfurter 12 (see FIG. 2). It should be noted that alternative embodiments of the device 10 can be configured to hold other types of foodstuffs such as corn dogs, beef on a stick, chicken on a stick, etc.

The device 10 comprises a body 14 and a lid 16. The lid 16 is capable of being secured to and removed from the body 16, and includes provisions for receiving the frankfurter 12. Details relating to these features are presented below.

Preferably, the body 14 is substantially cone-shaped as shown in FIGS. 1, 2, 6, and 7. It should be noted the body 14 can have other shapes, e.g., a cup shape, in alternative embodiments. The body 14 has a first end 14a, and a second, smaller-diameter end 14b. The body 14 is preferably formed from a recyclable material such as plastic or cardboard, although other types of materials can be used in the alternative.

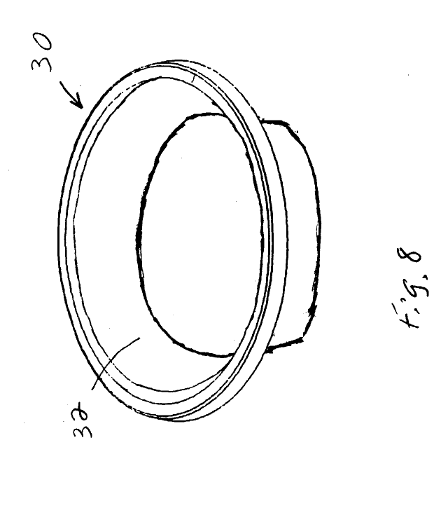

The device 10 preferably comprises a noisemaking device 18 fixedly coupled to the second end 14b of the body 16 (see FIGS. 1, 2, 6, and 7). The noisemaking device 18 is preferably in fluid communication with an internal volume of the body 14, as shown in FIG. 7. The noisemaking device 18 can be a whistle or a horn of the well-known type used in noisemakers (party favors). Other types of noisemaking devices can be used in the alternative. The purpose of the noisemaking device 18 is discussed below. It should be noted that alternative embodiments of the device 10 can be constructed without the noisemaking device 18 (the lid 16 may or may not be permanently secured to the body 14 in such embodiments).

The lid 16 preferably comprises a main portion 19 and an adjoining lip 20 (see FIGS. 1 and 3-5). The lip 20 extends around a circumference of the main portion 19. The lip 20 extends downwardly from the main portion 19 (from the perspective of FIG. 1).

The lip 20 helps to secure the lid 16 to the body 14. More specifically, the lip 20 is preferably sized so that the lip 20 interferes with the end 14a of the body 14 as the lid 16 is mated with the body 14. The lip 20 (and the remainder of the lid 16) are preferably formed from a material that permits the lip 20 to resiliently deflect in an outward direction in response to the noted contact with the end 14a. For example, the lip 20 can be formed from a thin sheet of plastic material. The resilience of the lip 20 causes the lip 20 to securely grasp the body 14, thereby securing the lid 16 to the body 14. The thickness of the lip 20 is preferably selected so that the mating force between the lip 20 and the body 14 is sufficient to prevent inadvertent removal of the lid 16, while permitting the lid 16 to be removed without the use of excessive force. It should be noted that structures other than the lip 20 can be used to secure the lid 16 to the body 14 in alternative embodiments.

The lid 16 further comprises an elongated portion 22. The elongated portion 22 is preferably shaped as a cylinder, although other geometric configurations can be used in alternative embodiments. A first end of the elongated portion 22 is fixedly coupled to the main portion 19 proximate a center thereof. The elongated portion 22 extends downward from the main portion 19 (from the perspective of FIG. 1). The elongated portion 22 is thus positioned within the body 14 when the lid 16 is secured to the body 14 (see FIG. 2). A hemispherical cap 24 is fixedly coupled to a second end of the elongated portion 22.

The elongated portion 22 and the cap 24 hold the frankfurter 12. More particularly, the elongated portion 22 preferably has a length sufficient to permit approximately half of the frankfurter 12 to fit therein (see FIG. 2). The diameter of the elongated portion 22 is preferably sized so that the elongated portion 22 holds the frankfurter 12 in a substantially upright position, as shown in FIG. 2, while allowing the frankfurter 12 to be inserted into and removed from the elongated portion 22 without substantial resistance.

It should be noted that the optimum values for the diameter and length of the elongated portion 22 will vary with the particular type or types of frankfurters (or other foodstuffs) with which the device 10 is used. Specific values for these dimensions therefore are not presented herein.

The lid 16 preferably includes one or more wells 26 (see FIGS. 1 and 3-5). The wells 26 extend downward from the main portion 19. The wells 26 can be used as trays for holding toppings for the frankfurter 12 such as mustard, relish, sauerkraut, ketchup, etc.

The main portion 19, lip 20, elongated portion 22, cap 24, and wells 26 can be unitarily formed by a suitable process such as injection molding.

The device 10 can be used, for example, by a food vendor at a sporting event. In particular, a foodstuff such as the frankfurter 12 can be sold to a customer with the frankfurter 12 inserted the elongated member 22, as shown in FIG. 2. The wells 26 can be filled with one or more toppings by the vendor before the device 10 and the frankfurter 12 are provided to the customer (the frankfurter 12 and toppings can thus be conveniently served as a single package). Alternatively, the customer can fill the wells 26 with one or more toppings from dispensers or packets of toppings provided by the vendor.

The body 14 can easily be held with one hand by children as well as adults, it is believed, due to its substantially conical shape. The frankfurter 12 can be removed from the device 10 and consumed in its entirety while being held in the other hand of the consumer (as is common for children attending a sporting event). Alternatively, the frankfurter 12 can be consumed, in part, while being held by the device 10. An end the frankfurter 12 can be dipped in the toppings held in the wells 26 as the frankfurter 12 is being consumed. Applying the toppings in this manner is believe to lessen the likelihood for the toppings to drip from the frankfurter 12 as the frankfurter 12 is consumed.

The lid 16 can be removed from the body 14 before or, more conveniently, after the frankfurter 12 has been consumed. The body 14 and the noisemaking device 18 can thereafter be used as an audible signaling device. In particular, the user can blow into the noisemaking device 18 to produce a sound. This activity can be undertaken in response to activities at the sporting event. For example, the noise produced by the body 14 and the noisemaking device 18 can be used as a form of fan participation signifying approval (or disapproval) of activities in the sporting event, in a manner similar to applause, whistling, shouting, etc.

The noisemaking device 18, as noted previously, is preferably in fluid communication with the internal volume of the body 14. The preferred cone-shaped geometry of the body 14 is believed to amplify or project the sound produced by the noisemaking device 18. This feature can potentially enhance the feeling of fan participation in the user. The body 14 and the noisemaking device 18 can subsequently serve as a souvenir or memento of the sporting event.

The exterior surface of the body 14 can be decorated in a manner that makes the device 10 attractive to children. For example, images of cartoon characters, sports figures, or the like can be printed on the exterior surface of the body 14. Commercial advertisements and team logos can also be placed on the body 14.

It should be noted that the above-described use of the device 10 has been presented for exemplary purposes only. The device 10 can be used in other ways, and at other types of public or non-public events, e.g., at circuses, birthday parties, barbecues, theme parks, movie theaters, etc.

It is to be understood that even though numerous characteristics and advantages of the present invention have been set forth in the foregoing description, the disclosure is illustrative only and changes may be made in detail within the principles of the invention to the full extent indicated by the broad general meaning of the terms in which the appended claims are expressed.

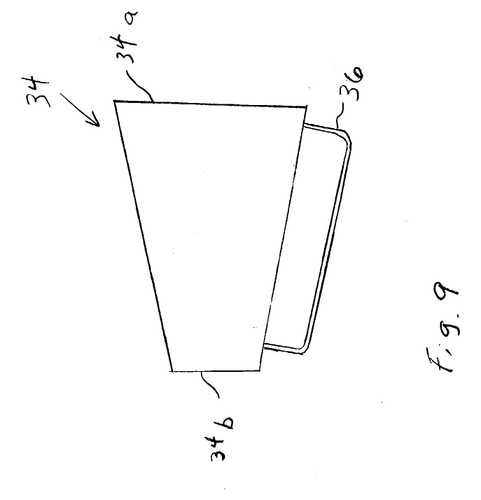

For example, the lid 16 can be modified to hold foodstuffs other than the frankfurter 12. One such modification is depicted in FIG. 8, which shows a lid 30 comprising a well 32 for holding ice cream or a similar foodstuff. The lid 30 can be used in conjunction with the body 14, in the manner described above with respect to the lid 16.

FIG. 9 depicts an alternative embodiment of the body 14. In particular, FIG. 9 depicts a body 34 that is not equipped with the noisemaking device 18. The body 34 has a first end 34a and a second end 34b. Preferably, the diameter of the second end 34b is sufficiently large to permit the body 34 to be used a megaphone when the lid 16 is not installed thereon. An optional handle 36 can be secured to the body 34 (this feature can also be applied to the body 14). The body 34 can be used in conjunction with the lid 16, in the manner described above with respect to the body 14.

What is claimed is:

1. A holder for a foodstuff, comprising:
a substantially cone-shaped body;
a lid comprising a main portion, a lip adjoining the main portion for securing the lid to a first end of the body, and an elongated member adjoining the main portion for receiving at least a portion of the foodstuff; and
a noisemaking device fixedly coupled to a second end of the body.

2. The holder of claim 1, wherein the noisemaking device is one of a whistle and a horn.

3. The holder of claim 1, wherein the lid further comprises a well adjoining the main portion for holding a topping for the foodstuff.

4. The holder of claim 1, wherein the elongated member is substantially cylindrically shaped.

5. The holder of claim 1, wherein the lid further comprises a hemispherical cap fixedly coupled to the elongated member.

6. The holder of claim 1, wherein the noisemaking device is fixedly coupled to a second end of the body so that the body at least one of amplifies and projects a sound produced by the noisemaking device.

7. The holder of claim 1, wherein the elongated member extends into the body when the lid is secured to the body.

8. The holder of claim 1, wherein the noisemaking device is in fluid communication with an internal volume of the body so that the noisemaking device and the lid cooperate to produce a sound in response to the passage of air through the noisemaking device.

9. The holder of claim 1, wherein the lip extends around a circumference of the lid.

10. The holder of claim 9, wherein the lip resiliently deflects when the lid is secured to the first end of the body and the resilient deflection of the lip secures the lid to the first end of the body.

11. The holder of claim 1, further comprising a handle secured to the body.

12. A device for holding a foodstuff, comprising:
a substantially cone-shaped body; a lid for mating with the body and receiving at least a portion of the foodstuff; and
a noisemaking device for generating a sound, wherein the noisemaking device is in fluid communication with an internal volume of the body so that the body at least one of amplifies and projects the sound when the lid is removed from the body.

13. The device of claim 12, wherein the noisemaking device is one of a whistle and a horn.

14. The device of claim 12, wherein the lid comprises a lip for securing the lid to the body, the lip extends around a circumference of the lid, the lip resiliently deflects when the lid is mated with the body, and the resilient deflection of the lip secures the lid to the body.

15. The device of claim 12, wherein the lid mates with a first end of the body and the noisemaking device is fixedly coupled to a second end of the body.

16. The device of claim 12, wherein the lid comprises a main portion, a lip adjoining the main portion for securing the lid the body, and an elongated member adjoining the main portion for receiving the at least a portion of a foodstuff.

17. A device, comprising:
a lid for holding at least a portion of a foodstuff;
a body for supporting the lid while the foodstuff is consumed; and
a noisemaking device secured to the body so that the noisemaking device and the body cooperate to produce a sound in response to the passage of air through the noisemaking device.

18. The device of claim 17, wherein the noisemaking device is one of a whistle and a horn.

19. The device of claim 17, wherein the lid comprises a lip for securing the lid to the body.

20. The device of claim 17, wherein the body is substantially cone shaped.

21. The device of claim 20, wherein the lid mates with a first end of the body and the noisemaking device is fixedly coupled to a second end of the body so that the body at least one of amplifies and projects the sound.

22. The device of claim 17, wherein the lid comprises a main portion, a lip adjoining the main portion for securing the lid to an end of the body, and an elongated member adjoining the main portion for receiving the at least a portion of a foodstuff

23. The device of claim 22, wherein the lid further comprises a well for holding a topping for the foodstuff.

24. A device for holding a foodstuff, comprising:
a substantially cone-shaped body; and
a lid comprising a main portion, a lip adjoining the main portion for securing the lid to the body, an elongated member projecting from the main portion for receiving at least a portion of the foodstuff, and a well adjoining the main portion for receiving a topping for the foodstuff.

25. The device of claim 24, further comprising a noisemaking device in fluid communication with an internal volume of the body.

26. A device, comprising:
a lid for holding at least a portion of a foodstuff;
a body for supporting the lid while the foodstuff is consumed; and
one of a whistle and a horn in fluid communication with an internal volume of the body, wherein the lid can be removed from the body so that the one of a whistle and a horn and the lid cooperate to produce a sound in response to the passage of air through the one of a whistle and a horn.

27. The device of claim 26, wherein the body is substantially cone shaped.

28. The device of claim 26, wherein the lid comprises a main portion, a lip adjoining the main portion for securing the lid to an end of the body, and an elongated member adjoining the main portion for receiving the at least a portion of a foodstuff.

29. The device of claim 28, wherein the lid further comprises a well for holding a topping for the foodstuff.
